(19) United States
(12) Patent Application Publication
(10) Pub. No.: US 2007/0236948 A1
(43) Pub. Date: Oct. 11, 2007

(54) Candle

(76) Inventor: Michael Restell, Wernberg-Koblitz (DE)

Correspondence Address: HOFFMAN WASSON & GITLER, P.C;CRYSTAL CENTER 2, SUITE 522, 2461 SOUTH CLARK STREET, ARLINGTON, VA, 22202-3843, US

(21) Appl. No.: 11/783,464

(22) Filed: Apr. 10, 2007

(30) Foreign Application Priority Data
Apr. 10, 2006 (DE) 20 2006 005 933.4
Sep. 16, 2006 (DE) 20 2006 014 209.6

(51) Int. Cl. F21V 35/00

(52) U.S. Cl. 362/392; 362/183; 362/800; 362/810

(57) ABSTRACT

The invention relates to a candle having a candle body, a candlewick and at least one electric illuminating module being integrated in said candle body. The candle body has a reservoir means capable of holding an inflammable liquid and the candlewick being connected to the reservoir means to assimilate the inflammable liquid.

### BACKGROUND OF THE INVENTION

The invention relates to a candle made up of a candle body, a candlewick, and at least one electric illuminating module being integrated in the candle body.

Candles with a minimum of one electrical light source, which has been integrated in the candle or which is substituting the flame of the candle, are already well known. For example, German Patent DE 20 2005 004 912 U1, discloses an electric candle for use with a common power supply, which has a device at the end of the candle body, so that the candle can be connected to the main power supply. This candle additionally has a light source, which may be a diode, and is powered by an electronic circuit within the candle body.

Also known are wicked candles made of wax with an electrically powered illumination means integrated in the candle body illuminating said candle body. The disadvantage of these candles is that the lit candle melts the wax and uses this as fuel, reducing the body of the candle and burning it down. After the natural time of use, only the electric illumination is left over, which is of no use then.

It is an object of the invention is to provide a candle with a candle body, a candlewick and at least one electric illumination means integrated in said candle body, which does not burn down and/or lose its function after use over a period of time in function.

### SUMMARY OF THE INVENTION

The candle according to the invention includes a candle body having integrated reservoir means capable of holding an inflammable liquid. A candlewick is partially inserted into said reservoir means holding said inflammable liquid. The advantage of the integrated reservoir means, which may be a bottle or an oil lamp module, is that it eliminates the burning down of the candle and therefore creates a durable candle, which may be used for a long time.

### BRIEF DESCRIPTION OF THE DRAWINGS

The invention is described by way of example in the following drawings which show in

FIG. 1 a simplified schematic drawing of an longitudinal section of said candle,

FIG. 2 a top view of the front end of the candle comprising a candlewick according to FIG. 1,

FIG. 3 a top view of the opposite back end of the candle according to FIG. 1, and

FIG. 4 a side view of said candle according to FIG. 1 having a coating.

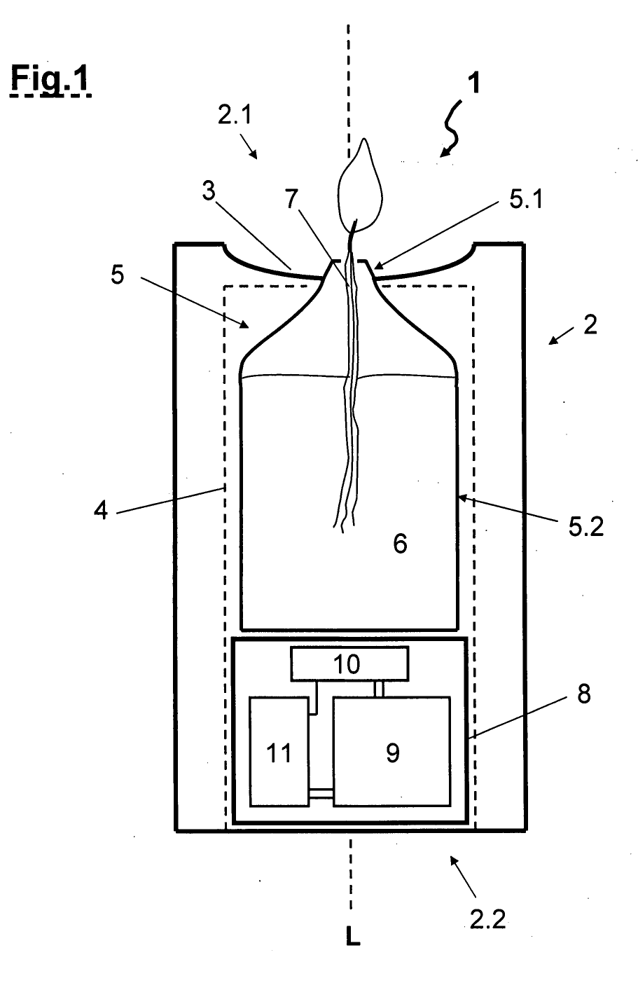

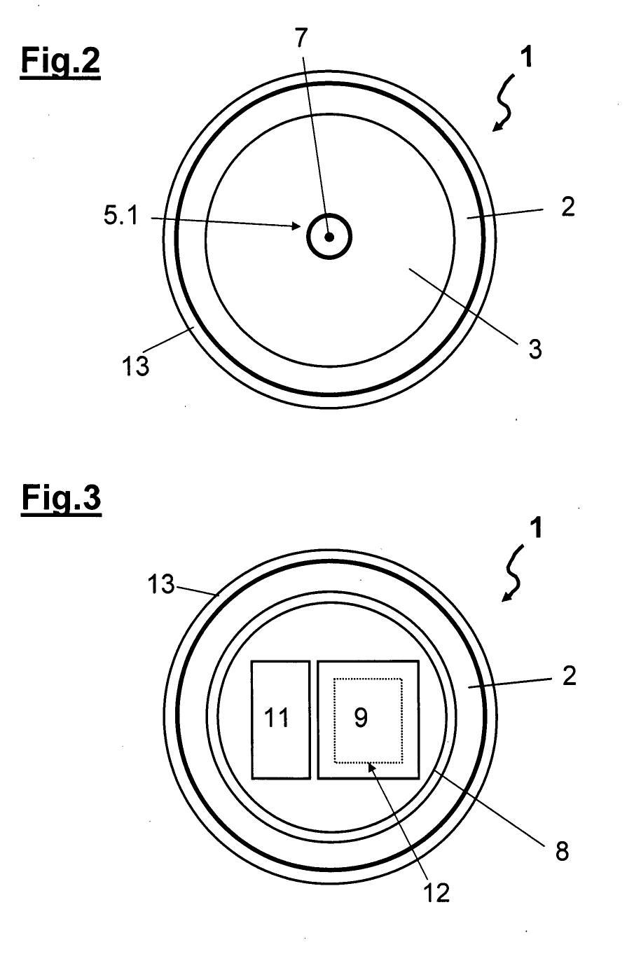

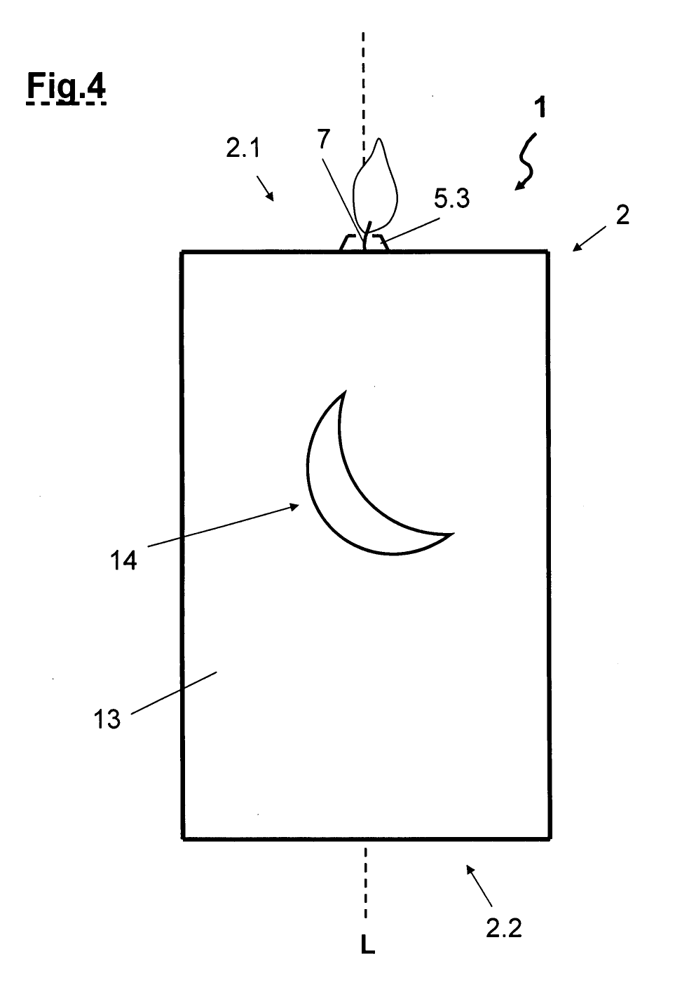

### DETAILED DESCRIPTION OF THE INVENTION

The schematic drawings show the figure of a standard candle 1 having a candle body 2 which may have—by way of example—a cylindrical shape. The candle 1 is not restricted to this shape and can be made in various shapes and sizes. The candle body 2 is made of wax or a similar translucent material such as glass or plastic.

The candle body 2 shows at the top 2.1 a depression 3 to simulate the design of a partly burnt candle. The depression 3 is calculated in depth and width to that of a natural burning candle 1. Therefore the flame will not melt the surrounding wax.

Inside the candle body 2 a recess 4 is provided having a hollow cylinder shape or cuboid shape and being open to the bottom 2.2 of the candle body 2.

The recess 4 is designed concentric to the longitudinal axis L of the candle body 2 and holds at least one reservoir means 5 and at least one source of illumination 8. The size and shape of the recess 4 is dependent on the size and shape of the candle and the components integrated into the candle 1. The reservoir means 5 are designed for the storage of an inflammable liquid 6. Favourably the reservoir means 5 is a bottle, designed to hold said inflammable liquid 6 and said candlewick 7. The candlewick 7 is at least partly inserted into the bottle-like reservoir means 5 and is held by a glass tip 5.3 at the top 2.1.

Glass bottle 5, candle wick 7 and tip 5.3 may be seen as a unit and be named oil lamp module. The oil lamp module shows a bottle neck 5.1, a bottle body 5.2 and a bottle tip 5.3. The oil lamp module is inserted into the recess 4 of the candle body 2 and the bottle neck 5.2 and the bottle tip 5.3 of the module project into the depression 3 at the top 2.1 of the candle 1.

Additionally, the recess 4 is occupied by an illumination unit named electric illumination module 8, consisting of an energy source 9 and an electric illuminating means 10. A controller unit 11 for the electric illuminating means 10 may be added in the electric illumination module 8, which is connected to said electric illuminating means 10 and said energy source 9. The electric illumination module 8 is located at the bottom 2.2 of the candle 1 as the source of illumination within the candle body 2.

The electric illumination module 8 is made up of at least one electric illuminating means 10 which may be controlled by the controller unit 11. Light intensity, light colour and number of active light sources of the illumination module are defined and controlled by the controller unit 11. The controller unit 11 contains a variety of predefined or definable sequences controlling the electric illumination module 8. The electric illumination means resp. light source 10 may be of any build or colour. Primarily the light source 10 may consist of light emitting diodes (LED).

The energy source 9 may consist of batteries or rechargeable batteries supplying the controller unit 11 and the electric illumination means resp. light source 10 with the electric power, needed for their full functioning.

The candle body 2 is at least partly made of wax or any other translucent material such as glass or plastic etc, so that the light, produced by the illumination module 8 may be seen from the outside of the candle body 2. The radiance of the ignited flame at the candlewick 7 of the candle body 2 may also be seen through the translucent material. Therefore the candle body 2 may show two different illuminative effects of radiance on the side surface of the body. At the top the radiance of the flame and at a lower level the radiance of the integrated illumination module 8.

In a standard configuration, the bottle-like reservoir means 5 and the electric illumination module 8 are moulded into the recess 4 to build one unit. A battery compartment 12 of the illumination module 8 is accessible from the bottom of the candle 1 to allow a change of batteries.

The candle body 2 may be at least partly surrounded by a coating 13 having at least one recess 14 releasing the candle body 2. Said coating 13 is made of light dimming or light impermeable material and may be exchangeable. The semi- or non-transparent material may be perforated with several recesses 14 of various shapes and forms. Through these shapes and forms the translucent material of the candle body 2 can be seen, and with that the illumination within the candle.

It is understood, that modifications and variations are possible, without leaving the basic principal of the invention.

### REFERENCE NUMBERS

1 candle
2 candle body
2.1 candle body top
2.2 candle body bottom
3 depression
4 recess
5 bottle-like reservoir means
5.1 bottle neck
5.2 bottle body
5.3 bottle tip
6 inflammable liquid
7 candle wick
8 electric illumination module
9 energy source
10 electric illuminating means
11 controller unit
12 battery compartment
13 coating
14 recess
L longitudinal axis

What is claimed is:

1. A candle comprising a candle body, a candlewick and at least one electric illuminating module being integrated in said candle body, wherein the candle body comprising reservoir means capable of holding a inflammable liquid, wherein said candlewick being connected to said reservoir means to assimilate said inflammable liquid.

2. The candle according to claim 1, wherein said reservoir means are formed by bottle-like reservoir module.

3. The candle according to claim 2, wherein said bottle-like reservoir module and said candlewick form an oil lamp module.

4. The candle according to claim 3, wherein said oil lamp module is arranged in a recess inside the candle body.

5. The candle according to claim 4, wherein said recess is open at the bottom of the candle body.

6. The candle according to claim 3, wherein said oil lamp module is arranged between at the top end of the candle body and said electronic illuminating module.

7. The candle according to claim 1, wherein said electric illuminating module comprising an electric energy source and at least one illuminating means.

8. The candle according to claim 7, wherein the electric illumination module comprises at least one controller unit.

9. The candle according to claim 7, wherein said electric illuminating module having illuminating means being controllable via said controller unit.

10. The candle according to claim 7, wherein said illuminating means being of varying colour.

11. The candle according to claim 7, wherein said illuminating means are diodes or light emitting diodes (LED).

12. The candle according to one claim 7, wherein said electric energy source having a compartment for batteries and/or rechargeable batteries.

13. The candle according to claim 8, wherein said controller unit randomly or periodically controlling light intensity, colour and light duration of said illuminating means.

14. The candle according to claim 1, wherein said candle body is at least partly made of a wax or any other translucent material.

15. The candle according to claim 1, wherein at least said reservoir means and said electronic illuminating module are removable attached or fixed to the candle body.

16. The candle according to claim 1, wherein at least said reservoir means and said electronic illuminating module are molded in said candle body.

17. The candle according to claim 1, wherein said candle body is at least partly surrounded by a coating having at least one recess releasing the candle body.

18. The candle according claim 17, wherein said coating is made of light dimming or light impermeable material.

19. The candle according to claim 17, wherein said coating is exchangeable.
